(19) United States
(12) Patent Application Publication
(10) Pub. No.: US 2026/0305720 A1
(43) Pub. Date: Oct. 8, 2026

(54) AEROSOL-GENERATING DEVICE WITH INTERNAL AND EXTERNAL HEATING ARRANGEMENT

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH); Julien VIDAL, Peseux (CH)

(73) Assignee: Philip Morris Products S.A., Neuchatel (CH)

(21) Appl. No.: 19/477,918

(22) PCT Filed: Apr. 25, 2024
(86) PCT No.: PCT/EP2024/061439

§ 371 Date: Oct. 23, 2025

(30) Foreign Application Priority Data
May 2, 2023 (EP) 23171171

(51) Int. Cl. A24F 40/57; A24F 40/20; A24F 40/46; A24F 40/465; H05B 6/04; H05B 6/06; H05B 6/10

(52) U.S. Cl. CPC A24F 40/57; A24F 40/46; A24F 40/465; H05B 6/04; H05B 6/06; H05B 6/105; A24F 40/20

(57) ABSTRACT

An aerosol-generating device is provided, including: a housing defining a chamber to receive at least a portion of an aerosol-generating article; an inductor coil disposed in the housing and being configured to surround the article when the article is received in the chamber; a power supply to provide electrical power to the inductor coil; and control circuitry configured to: control a supply of power from the power supply to the inductor coil, provide an alternating current to the inductor coil, such that the inductor coil generates an alternating magnetic field to inductively heat a susceptor within the article, provide a direct current to the inductor coil to resistively heat the inductor coil and thereby heat the article, and following activation of the device, initially provide alternating current to the inductor coil and to subsequently provide direct current to the inductor coil.

The present disclosure relates to an aerosol-generating system and an aerosol-generating device for generating an aerosol from an aerosol-forming substrate.

It is known to evolve an aerosol from an aerosol-forming substrate of an aerosol-generating article by the application of heat to the substrate, without burning or combustion of the substrate. The aerosol-generating article may be cylindrical, like a cigarette, and the aerosol-forming substrate may comprise tobacco material. It is known to apply heat to such an aerosol-generating article to heat the aerosol-forming substrate of the article using a heat source that is external to the aerosol-generating article.

However, an external heat source will tend to heat the aerosol-forming substrate unevenly. The aerosol-forming substrate closest to the heat source will be heated more than the aerosol-forming substrate in the centre of the aerosol-generating article, further from the heat source.

It is also known to heat the aerosol-forming substrate of such an article using a heat source located within the interior of the aerosol-forming substrate. In some aerosol-generating systems the internal heat source is heated inductively using an induction coil positioned externally of the aerosol-generating article and a susceptor material located within a central region of the aerosol-generating article. Internally heating the aerosol-forming substrate avoids heat having to traverse through a wrapper to reach the aerosol-forming substrate. However, internally heating the aerosol-forming substrate also results in the aerosol-forming substrate being heated in a non-uniform manner, with heating of the substrate being greatest at or closest to the internal heat source and reducing with increasing distance away from the internal heat source into the substrate.

Non-uniform heating of the aerosol-forming substrate can mean that not all of the available volatile material is released from the aerosol-forming substrate. This is because increasing the level of heat applied to the substrate in order to fully extract the volatile material from the aerosol-forming substrate when using either external heating or internal heating of the substrate may result in unintended and undesired burning of the substrate close to the heat source, which can give rise to the generation of undesirable compounds and flavours.

It is therefore desired to provide an aerosol-generating system and an aerosol-generating device for generating an aerosol from an aerosol-forming substrate that efficiently and uniformly heats an aerosol-forming substrate without requiring a complex heating arrangement.

According to the present disclosure, there is provided an aerosol-generating device. The aerosol-generating device may comprise a housing defining a chamber for receiving at least a portion of an aerosol-generating article. The aerosol-generating device may comprise an inductor coil disposed in the housing. The aerosol-generating device may comprise at least one power supply for providing electrical power to the inductor coil. The aerosol-generating device may comprise control circuitry configured to control the supply of power from the at least one power supply to the inductor coil. The control circuitry may be configured to provide an alternating current to the inductor coil, such that the inductor coil generates an alternating magnetic field to inductively heat a susceptor within the aerosol-generating article.

The control circuitry may be configured to provide a direct current to the inductor coil to resistively heat the inductor coil and thereby heat the aerosol-generating article.

According to a first aspect of the disclosure, there is provided an aerosol-generating device comprising:
a housing defining a chamber for receiving at least a portion of an aerosol-generating article;
an inductor coil disposed in the housing;
at least one power supply for providing electrical power to the inductor coil; and
control circuitry configured to control the supply of power from the at least one power supply to the inductor coil, wherein the control circuitry is configured to provide an alternating current to the inductor coil, such that the inductor coil generates an alternating magnetic field to inductively heat a susceptor within the aerosol-generating article, and to provide a direct current to the inductor coil to resistively heat the inductor coil and thereby heat the aerosol-generating article.

Using a single coil to provide both heating power to an internal susceptor and to provide resistive heating of the coil itself provides two different heat sources in different locations relative to the aerosol-forming substrate with a structure that is no more complex than a typical induction heating arrangement.

The device is able to change the mode of application of heat to the aerosol-forming substate to any one of the following heating regimes:
a) solely or predominantly through the resistive heating of the inductor coil;
b) solely or predominantly through heating of the susceptor through the inductive coupling of the inductor coil with the susceptor;
c) a combination of resistive heating of the inductor coil and heating of the susceptor through the inductive coupling of the inductor coil with the susceptor.

The control circuitry may be configured to adjust the alternating current provided to the inductor coil during operation of the device to adjust an amount of heating provided by inductive heating.

The control circuitry may be configured to adjust the direct current provided to the inductor coil during operation of the device to adjust an amount of heating provided by resistive heating.

The control circuitry may be configured to provide the alternating current and the direct current to the inductor coil at different times. For example, following activation of the device the control circuitry may be configured to initially provide alternating current to the inductor coil and to subsequently provide direct current to the inductor coil. This may provide for rapid generation of aerosol at the outset of a usage session, but also provide for complete and efficient heating of the entire aerosol-forming substrate over a full usage session. At the beginning of a usage session, inductive heating of an internal susceptor may provide aerosol more quickly than external resistive heating because the susceptor can be in closer contact with the aerosol-forming substrate. An internal susceptor may also be heated more quickly than the external inductor coil if the susceptor has a lower thermal mass than the inductor coil.

The control circuitry may be configured to provide the alternating current and the direct current to the inductor coil in an alternating sequence. It may be beneficial to alternate external and internal heating in order to avoid overheating of any part of the aerosol-forming substrate.

The control circuitry may be configured to provide both alternating current and direct current to the inductor coil concurrently. In this way a larger amount of heat energy can be transferred to the aerosol-forming substrate to generate a larger volume of aerosol, without either the susceptor or coil reaching a temperature at which any part of the aerosol-generating article might combust.

There are many possible ways to combine the heating of the internal susceptor and the heating of the external coil. For example, the inductive heating of the susceptor may be controlled to follow a particular profile over the course of a usage session and the resistive heating of the inductor coil may be controlled to follow a different profile over the course of the usage session. The profiles may be chosen to provide consistent aerosol delivery over the course of the usage session as well as providing heating of substantially all of the aerosol-forming substrate.

The control circuitry may be configured to adjust the direct current provided to the inductor coil to maintain the temperature of the inductor coil at a target temperature or to follow a target temperature profile.

The control circuitry may be configured to adjust the alternating current provided to the inductor coil to maintain the temperature of the susceptor at a target temperature or to follow a target temperature profile.

The control circuitry may be configured to:
during a first phase, control a supply of alternating current according to a first phase internal power supply profile and control a supply of direct current according to a first phase external power supply profile, optionally so as to increase a temperature of at least the susceptor during the first phase; and
during a second phase subsequent to the first phase, control a supply of alternating current according to a second phase internal power supply profile and control a supply of direct current according to a second phase external power supply profile, optionally so as to increase a temperature of at least the inductor coil during the second phase.

An average temperature of the inductor coil during the second phase may be greater than an average temperature of the inductor coil during the first phase. A frequency of the alternating current in the first phase may be different to a frequency of the alternating current in the second phase.

The control circuitry may be configured to start the second phase in response to:
a predetermined number of puffs on the system being taken; or
a predetermined time from a first puff on the system passing; or
a user-activatable trigger being activated; or
a combination of any one or more of the above.

The control circuitry may be configured to alter a magnitude of the direct current during operation of the device to adjust an amount of heat generated in the inductor coil as a result of the direct current.

The control circuitry may be configured to alter a magnitude of the alternating current during operation of the device to adjust an amount of heat generated in the susceptor and in the inductor coil as a result of the alternating current.

The control circuitry may be configured to adjust a frequency of the alternating current during operation of the device to adjust an amount of heat generated in the susceptor and in the inductor coil as a result of the alternating current.

The inductive coupling between the inductor coil and susceptor varies with changes in frequency of the alternating current. The frequency may be adjusted to have a value f_{susceptor}, associated with an alternating current creating a varying magnetic field that maximises a transfer of energy to the susceptor, resulting in most of the heat being generated by heating of the susceptor. The frequency may also be adjusted to have a value f_{inductor coil}, associated with an alternating current creating a magnetic field that provides little to no transfer of energy to the susceptor, resulting in most of the heat being generated by resistance heating of the inductor coil. The frequency may also be adjusted to have a value fₜₒₜₐₗ, associated with an alternating current which results in a combination of heating of the susceptor and resistance heating of the inductor coil. Each of these frequencies will vary depending on the materials, physical properties and configuration of the inductor and susceptor, such as the inductance of the inductor coil and magnetic permeability of the material(s) employed for the susceptor.

The control circuitry may be configured to adjust the frequency of the alternating current from a first frequency value or range of values to a second frequency value or range of values. The first frequency value or range of values corresponds to a first heating state of the electric heating arrangement and the second frequency value or range of values corresponds to a second heating state of the electric heating arrangement. Preferably, the second frequency value or range of values may be closer than the first frequency value or range of values to a resonant frequency of the electric heating arrangement, such that the inductive coupling of the inductor coil with the susceptor is increased in the second heating state compared to the first heating state. Advantageously, the control circuitry may be configured to trigger adjustment of the frequency of the alternating current between the first and second values or range of values as a function of one or more of: a) a puff count over a usage session; b) time elapsed since commencement of a usage session; c) detection of a puff in a usage session. The control circuitry may be configured to adjust the frequency of the alternating current from the first frequency value or range of values to the second frequency value or range of values in response to receiving a signal indicative of a user puff. The control circuitry may be configured to maintain the frequency of the alternating current at the second frequency value or range of values for a predetermined period of time after receiving the signal indicative of a puff being applied to the aerosol-generating system.

The control circuitry may be configured to, after elapse of the predetermined period of time, adjust the frequency of the alternating current from the second frequency value or range of values to a third frequency value or range of values. The third frequency value or range of values corresponds to a third heating state of the electric heating arrangement. The third frequency value or range of values is farther away than the second frequency value or range of values from the resonant frequency of the electric heating arrangement, such that the inductive coupling of the inductor coil with the susceptor is reduced in the third heating state compared to the second heating state.

The resonant frequency may be determined according to the following equation:

$${f}_{R} = \frac{1}{2 π \sqrt{LC}}$$

in which f_{R} is the resonant frequency, L is an inductance of the electric heating arrangement and C is a capacitance of the electric heating arrangement.

In a similar manner to the control of the supply of alternating current as described above, the control circuitry may be configured to activate or adjust the supply of direct current to the inductor coil as a function of one or more of a) a puff count over a usage session; b) time elapsed since commencement of a usage session; and c) detection of a puff in a usage session.

The control circuitry may be configured to activate or increase the supply of direct current to the inductor coil in response to the control circuitry receiving a signal indicative of a user puff.

Conveniently, the control circuitry may be configured to switch between one or more of the following operational states:
a) a first operational state in which the inductor coil is supplied with alternating current alone;
b) a second operational state in which the inductor coil is supplied with direct current alone; and
c) a third operational state in which the inductor coil is supplied with both alternating current and direct current.

Preferably, the control circuitry may be configured to select between different ones of the first, second and third operational states as a function of one or more of:
a) a puff count over a usage session;
b) time elapsed since commencement of a usage session; and
c) detection of a puff in a usage session.

The inductor coil may be in the chamber. The inductor coil may configured to be in direct contact with an exterior surface of the aerosol-generating article. This maximises conductive heat transfer from the inductor coil to the aerosol-generating article.

The aerosol-generating device may further comprise a thermally conductive bridging element, the bridging element positioned in direct contact with the inductor coil and configured to contact an exterior surface of the aerosol-generating article so as to conduct heat generated in the inductor coil to the aerosol-generating article.

At least one of the control circuitry and the thermally conductive bridging element may be configured to prevent inductive coupling between the thermally conductive bridging element and the inductor coil during use.

The control circuitry may be configured to provide the alternating current with a frequency selected to prevent inductive coupling between the thermally conductive bridging element and the inductor coil during use.

The thermally conductive bridging element may be formed from a non-electrically conductive material. The thermally conductive bridging element may be formed from a non-inductively heatable material. The thermally conductive bridging element may comprise at least one of a polymeric material and a metal. The thermally conductive bridging element may comprise at least one of aluminium and a paramagnetic steel. The paramagnetic steel may comprise an austenitic steel. The thermally conductive bridging element may comprise a polymeric material and at least one of graphite, a graphite-derived material, and hexagonal boron nitride dispersed within the polymeric material. The polymeric material may comprise at least one of polyether ether ketone (PEEK) and a liquid crystal polymer (LCP). The thermally conductive bridging element may comprise the polymeric material in an amount of between 22 percent and 33 percent by weight of the thermally conductive bridging element. The graphite-derived material may comprise at least one of expanded graphite and graphite nanoplatelets. The thermally conductive bridging element may comprise the at least one of graphite, a graphite-derived material, and hexagonal boron nitride in an amount of between 62 percent and 69 percent by weight of the thermally conductive bridging element. The thermally conductive bridging element may further comprise at least one additive dispersed within the polymeric material. The at least one additive may comprise carbon black. The thermally conductive bridging element may comprise the at least one additive in an amount of between 5 percent and 9 percent by weight of the thermally conductive bridging element.

The power supply and the control circuitry may be connected to the thermally conductive bridging element and configured to provide an electric current to the thermally conductive bridging element during use to resistively heat the thermally conductive bridging element.

The inductor coil may be configured to surround the aerosol-forming article when the aerosol forming article is received in the chamber. This allows for both a concentrated magnetic field around the susceptor and for heating around a full circumference of the aerosol-generating article by resistive heating of the coil itself.

The susceptor may comprise a susceptor element. The aerosol-generating device may comprise the susceptor element and the susceptor element may be within the chamber. The susceptor element may be arranged to be positioned within the aerosol-forming article when the aerosol forming article is received in the chamber. The susceptor element may be an elongate susceptor element extending into the chamber from the closed second end of the chamber. At least a portion of the elongate susceptor element may be positioned inside the inductor coil. The susceptor element may form all or part of a pin or blade configured to penetrate the aerosol-forming article when the aerosol forming article is received in the chamber.

The inductor coil may be suspended inside the chamber. This reduces heat losses from the coil to the housing and so improves the efficiency of the device. The inductor coil may be a helical coil. The helical coil may comprise a first end and a second end. The housing may contact the inductor coil only at the first end and the second end of the inductor coil.

The housing may comprise an inner surface at least partially defining the chamber. Each of the first end of the inductor coil and the second end of the inductor coil may abut the inner surface of the housing. The inner surface of the housing may define a first recess and a second recess, wherein the first end of the inductor coil is positioned within the first recess and wherein the second end of the inductor coil is positioned within the second recess.

The inner surface of the housing may define a first slot and a second slot, wherein the first end of the inductor coil extends through the first slot and wherein the second end of the inductor coil extends through the second slot. An outer surface of the inductor coil may be spaced apart from the inner surface of the housing.

The chamber may comprise an open first end through which at least a portion of an aerosol-generating article may be inserted into the chamber and a closed second end opposite the open first end.

The aerosol-generating device may further comprise an airflow channel defined between the inner surface of the housing and the outer surface of the inductor coil, wherein the airflow channel provides fluid communication between the first end of the chamber and the second end of the chamber.

The aerosol-generating device may further comprise at least one protrusion extending into the chamber from the closed second end of the chamber. The housing may comprise an end wall defining the closed second end of the chamber. The at least one protrusion may extend into the chamber from the end wall. The at least one protrusion may be formed integrally with the end wall. The at least one protrusion may comprise at least three protrusions. The chamber may have a longitudinal axis defining a first direction along which at least a portion of an aerosol-generating article may be inserted into the chamber. The at least three protrusions may be equidistantly spaced from each other in a circumferential direction around the longitudinal axis.

The inductor coil may be arranged so that, when an aerosol-generating article is inserted into the chamber, at least part of the aerosol-generating article is received within the inductor coil. The inductor coil may be arranged so that, when an aerosol-generating article is inserted into the chamber, the inductor coil directly contacts the aerosol-generating article.

The inductor coil may be formed from a coiled wire. The coiled wire may comprise an electrically conductive core and a coating on the electrically conductive core. The coating may be electrically insulating. The coating may comprise at least one of a polymer, a ceramic, and a glass.

The inductor coil may comprise a metal. The metal may comprise copper or stainless steel.

The inductor coil may comprise:
a first tubular portion of electrically conductive material;
a second tubular portion of electrically conductive material; and
a helical coil of electrically conductive material extending between the first tubular portion of electrically conductive material and the second tubular portion of electrically conductive material.

The helical coil may be formed integrally with the first tubular portion and the second tubular portion. Preferably, each of the first tubular portion, the second tubular portion, and each turn of the helical coil has a maximum width extending in a direction parallel to a longitudinal axis of the inductor coil, wherein the maximum width of each of the first tubular portion and the second tubular portion is greater than the maximum width of each turn of the helical coil.

The inductor coil may comprise a plurality of discrete apertures in at least one of the first tubular portion of electrically conductive material and the second tubular portion of electrically conductive material. The plurality of discrete apertures may be present in both the first tubular portion of electrically conductive material and the second tubular portion of electrically conductive material. The plurality of discrete apertures may be distributed symmetrically in a circumferential direction extending around a longitudinal axis of the inductor coil. Each of the discrete apertures may have a circular shape, a triangular shape, a rectangular shape, a pentagonal shape, a hexagonal shape, a heptagonal shape, or an octagonal shape.

The inductor coil may further comprise a layer of electrically insulating material extending around an outer surface of the first tubular portion, the second tubular portion and the helical coil. The layer of electrically insulating material may comprise a strip of the electrically insulating material extending around the outer surface of the first tubular portion, the second tubular portion and the helical coil. The strip of electrically insulating material may extend in a helical shape around the outer surface of the first tubular portion, the second tubular portion and the helical coil. The helical strip of electrically insulating material may be wound in a first direction, wherein the helical coil turns in a second direction, and wherein the second direction is opposite to the first direction. The layer of electrically insulating material may be overmoulded on the outer surface of the first tubular portion, the second tubular portion and the helical coil.

The helical coil of electrically conductive material may have an inner surface, and at least one edge of the turns of the helical coil may comprises a bevel, a chamfer or a fillet.

The inductor coil may comprise a core layer comprising a material of a first electrical resistivity and an outer layer comprising a material of a second electrical resistivity, wherein the first electrical resistivity is higher than the second electrical resistivity. Heat generated by the direct current in the coil is generated primarily in the core layer. The alternating current is conducted primarily in the outer layer, and generates little heat as a result of Joule heating An electrically insulating layer may be present between the core layer and the outer layer.

The power supply may comprise a first DC power source. The first DC power source may be a battery. The control circuitry may comprise a DC/AC converter connected to the first DC power source.

The control circuitry preferably comprises power supply electronics configured to operate at high frequency. The power supply electronics comprises the DC/AC converter connected to the first DC power source, the DC/AC converter including a Class-E power amplifier including a first transistor switch and an LC load network. The LC load network may comprise a shunt capacitor and a series connection of a capacitor and the inductor coil. The power supply electronics preferably include a second DC power source connected to the LC load network at a position between the capacitor and the inductor coil for supplying DC current to the inductor coil. The second DC power source may be the same power source as the first DC power source, e.g. they may be the same battery. The power supply electronics may include a choke inductor between the second DC power source and the capacitor. The choke inductor preferably has a higher inductance value than the inductor coil. The power supply electronics may also include a choke inductor between the first DC power source and the capacitor. The power supply electronics may include a second switch between the second DC power source and the inductor coil. The second switch may be a second transistor switch.

The power supply electronics may include second capacitor connected in parallel with the inductor coil. This may reduce a difference between f_{susceptor} and f_{inductor coil}.

For the purpose of this application, the term “high frequency” is to be understood to denote a frequency ranging from about 1 Megahertz (MHz) to about 30 Megahertz (MHz) (including the range of 1 MHz to 30 MHz), in particular from about 1 Megahertz (MHz) to about 10 MHz (including the range of 1 MHz to 10 MHz), and even more particularly from about 5 Megahertz (MHz) to about 7 Megahertz (MHz) (including the range of 5 MHz to 7 MHz).

Class-E power amplifiers are generally known and are described in detail, for example, in the article “Class-E RF Power Amplifiers”, Nathan O. Sokal, published in the bimonthly magazine QEX, edition January/February 2001, pages 9-20, of the American Radio Relay League (ARRL), Newington, CT, U.S.A., Class-E power amplifiers are advantageous as regards operation at high frequencies while at the same time having a simple circuit structure comprising a minimum number of components (e.g. only one transistor switch needed, which is advantageous over Class-D power amplifiers which comprise two transistor switches that must be controlled at high frequency in a manner so as to make sure that one of the two transistors has been switched off at the time the other of the two transistors is switched on). In addition, Class-E power amplifiers are known for minimum power dissipation in the switching transistor during the switching transitions. Preferably, the Class-E power amplifier is a single-ended first order Class-E power amplifier having a single transistor switch only.

The transistor switch of the Class-E power amplifier can be any type of transistor and may be embodied as a bipolar-junction transistor (BJT). More preferably, however, the transistor switch is embodied as a field effect transistor (FET) such as a metal-oxide-semiconductor field effect transistor (MOSFET) or a metal-semiconductor field effect transistor (MESFET).

The LC load network of the Class-E power amplifier of the induction heating device according to the invention is configured to operate at low ohmic load. The term “low ohmic load” is to be understood to denote an ohmic load smaller than about 2 Ohms. The LC load network comprises a shunt capacitor, and a series connection of a capacitor and an inductor having an ohmic resistance. This ohmic resistance of the inductor is typically a few tenths of an Ohm. In operation, the ohmic resistance of the susceptor adds to the ohmic resistance of the inductor and should be higher than the ohmic resistance of the inductor, since the supplied electrical power should be converted to heat in the susceptor to an as high extent as possible in order to increase efficiency of the power amplifier and to allow transfer of as much heat as possible from the susceptor to the rest of the aerosol-forming substrate to effectively produce the aerosol.

In another aspect of the disclosure, there is provided an aerosol-generating system comprising:
an aerosol-generating article comprising an aerosol-generating substrate; and
an aerosol-generating device according to the first aspect of the disclosure, wherein the aerosol-generating article is received in the chamber of the aerosol-generating device.

The aerosol-generating article may comprise one or more susceptors. The aerosol-generating article may comprise tobacco material.

As used herein, the term “aerosol-generating article” refers to an article comprising an aerosol-forming substrate that is capable of releasing volatile compounds that can form an aerosol. An aerosol-generating article may be disposable.

In accordance with the present disclosure, there is provided a method of controlling an aerosol-generating system to generate an aerosol. The system may comprise an aerosol-generating article comprising an aerosol-generating substrate. The system may comprise a housing defining a chamber receiving at least a portion of the aerosol-generating article. The system may comprise an inductor coil disposed in the housing. The system may comprise at least one power supply for providing electrical power to the inductor coil. The system may comprise control circuitry configured to control the supply of power from the at least one power supply to the inductor coil. The method may comprise providing an alternating current to the inductor coil, such that the inductor coil generates an alternating magnetic field to inductively heat a susceptor within the aerosol-generating article. The methos may comprise providing a direct current to the inductor coil to resistively heat the inductor coil and thereby heat the aerosol-generating article.

In a further aspect of the disclosure, there is provided a method of controlling an aerosol-generating system to generate an aerosol, the system comprising:
an aerosol-generating article comprising an aerosol-generating substrate;
a housing defining a chamber receiving at least a portion of the aerosol-generating article;
an inductor coil disposed in the housing;
at least one power supply for providing electrical power to the inductor coil; and
control circuitry configured to control the supply of power from the at least one power supply to the inductor coil,
the method comprising:
providing an alternating current to the inductor coil, such that the inductor coil generates an alternating magnetic field to inductively heat a susceptor within the aerosol-generating article, and
providing a direct current to the inductor coil to resistively heat the inductor coil and thereby heat the aerosol-generating article.

The method may comprise adjusting the alternating current during operation of the device to adjust an amount of heating provided by inductive heating.

The method may comprise adjusting the direct current to inductor coil during operation of the device to adjust an amount of heating provided by resistive heating.

The method may comprise providing the alternating current and the direct current to the inductor coil at different times.

The method may comprise, following activation of the device, initially providing alternating current to the inductor coil and subsequently providing direct current to the inductor coil.

The method may comprise providing both alternating current and direct current to the inductor coil concurrently.

The method may comprise altering a magnitude of the direct current during operation of the device to adjust an amount of heat generated in the inductor coil as a result of the direct current.

The method may comprise altering a magnitude of the alternating current during operation of the device to adjust an amount of heat generated in the susceptor and in the inductor coil as a result of the alternating current.

The method may comprise adjusting a frequency of the alternating current during operation of the device to adjust an amount of heat generated in the susceptor and in the inductor coil as a result of the alternating current.

The method may comprise adjusting the direct current provided to the inductor coil to maintain the temperature of the inductor coil at a target temperature or to follow a target temperature profile.

The method may comprise adjusting the alternating current provided to the inductor coil to maintain the temperature of the susceptor at a target temperature or to follow a target temperature profile.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

As used herein, the term “usage session” refers to a period in which a series of puffs are applied by a user to extract aerosol from an aerosol-forming substrate.

As used herein, the term “mouthpiece” refers to a portion of an aerosol-generating article, an aerosol-generating device or an aerosol-delivery system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating device may also be referred to as the upstream end. Components, or portions of components, of the aerosol-generating device may be described as being upstream or downstream of one another based on their relative positions with respect to the airflow path of the aerosol-generating device. As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

The invention is defined in the claims. However, below there is provided a non-exhaustive list of non-limiting examples. Any one or more of the features of these examples may be combined with any one or more features of another example, embodiment, or aspect described herein.
EX1. An aerosol-generating device comprising:
a housing defining a chamber for receiving at least a portion of an aerosol-generating article;
an inductor coil disposed in the housing;
at least one power supply for providing electrical power to the inductor coil; and
control circuitry configured to control the supply of power from the at least one power supply to the inductor coil, wherein the control circuitry is configured to provide an alternating current to the inductor coil, such that the inductor coil generates an alternating magnetic field to inductively heat a susceptor within the aerosol-generating article, and to provide a direct current to the inductor coil to resistively heat the inductor coil and thereby heat the aerosol-generating article.
EX2. An aerosol-generating device according to example EX1, wherein the control circuitry is configured to adjust the alternating current provided to the inductor coil during operation of the device to adjust an amount of heating provided by inductive heating.
EX3. An aerosol-generating device according to example EX1 or EX2, wherein the control circuitry is configured to adjust the direct current provided to the inductor coil during operation of the device to adjust an amount of heating provided by resistive heating.
EX4. An aerosol-generating device according to example EX1, EX2 or EX3, wherein the control circuitry is configured to provide the alternating current and the direct current to the inductor coil at different times.
EX5. An aerosol-generating device according to example EX4, wherein the control circuitry is configured, following activation of the aerosol-generating device, to initially provide alternating current to the inductor coil and to subsequently provide direct current to the inductor coil.
EX6. An aerosol-generating device according to any preceding example, wherein the control circuitry is configured to provide the alternating current and the direct current to the inductor coil in an alternating sequence.
EX7. An aerosol-generating device according to any preceding example, wherein the control circuitry is configured to provide both alternating current and direct current to the inductor coil concurrently.
EX8. An aerosol-generating device according to any preceding example, wherein the control circuitry is configured to adjust the direct current provided to the inductor coil to maintain the temperature of the inductor coil at a target temperature or to follow a target temperature profile.
EX9. An aerosol-generating device according to any preceding example, wherein the control circuitry is configured to adjust the alternating current provided to the inductor coil to maintain the temperature of the susceptor at a target temperature or to follow a target temperature profile.
EX10. An aerosol-generating device according to any preceding example, wherein the control circuitry is configured to:
during a first phase, control a supply of alternating current according to a first phase internal power supply profile and control a supply of direct current according to a first phase external power supply profile, optionally so as to increase a temperature of at least the susceptor during the first phase; and
during a second phase subsequent to the first phase, control a supply of alternating current according to a second phase internal power supply profile and control a supply of direct current according to a second phase external power supply profile, optionally so as to increase a temperature of at least the inductor coil during the second phase.
EX11. An aerosol-generating device according to example EX10, wherein an average temperature of the inductor coil during the second phase is greater than an average temperature of the inductor coil during the first phase.
EX12. An aerosol-generating device according to example EX10 or EX11, wherein a frequency of the alternating current in the first phase is different to a frequency of the alternating current in the second phase.
EX13. An aerosol-generating device according to example EX10, EX11 or EX12, wherein the control circuitry is configured to start the second phase in response to:
a predetermined number of puffs on the system being taken; or
a predetermined time from a first puff on the system passing; or
a user-activatable trigger being activated; or
a combination of any one or more of the above.
EX14. An aerosol-generating device according to any preceding example, wherein the control circuitry is configured to alter a magnitude of the direct current during operation of the device to adjust an amount of heat generated in the inductor coil as a result of the direct current.
EX15. An aerosol-generating device according to any preceding example, wherein the control circuitry is configured to alter a magnitude of the alternating current during operation of the device to adjust an amount of heat generated in the susceptor and in the inductor coil as a result of the alternating current.
EX16. An aerosol-generating device according to any preceding example, wherein the control circuitry is configured to adjust a frequency of the alternating current during operation of the device to adjust an amount of heat generated in the susceptor and in the inductor coil as a result of the alternating current.
EX17. An aerosol-generating device according to any preceding example, wherein the inductive coupling between the inductor coil and susceptor varies with changes in frequency of the alternating current.
EX18. An aerosol-generating device according to example EX17, wherein the control circuitry is configured to adjust the frequency of the alternating current to have a value f_{susceptor}, associated with an alternating current creating a varying magnetic field that maximises a transfer of energy to the susceptor, resulting in most of the heat being generated by heating of the susceptor.
EX19. An aerosol-generating device according to example EX17 or EX18, wherein the control circuitry is configured to adjust the frequency of the alternating current to have a value f_{inductor coil}, associated with an alternating current creating a magnetic field that provides little to no transfer of energy to the susceptor, resulting in most of the heat being generated by resistance heating of the inductor coil.
EX20. An aerosol-generating device according to example EX17, EX18 or EX19, wherein the control circuitry is configured to adjust the frequency to have a value fₜₒₜₐₗ, associated with an alternating current which results in a combination of heating of the susceptor and resistance heating of the inductor coil.
EX21. An aerosol-generating device according to any preceding example, wherein the control circuitry is configured to adjust the frequency of the alternating current from a first frequency value or range of values to a second frequency value or range of values.
EX22. An aerosol-generating device according to example EX21, wherein the first frequency value or range of values corresponds to a first heating state of the electric heating arrangement and the second frequency value or range of values corresponds to a second heating state of the electric heating arrangement.
EX23. An aerosol-generating device according to example EX21 or EX22, wherein the second frequency value or range of values is closer than the first frequency value or range of values to a resonant frequency of the electric heating arrangement, such that the inductive coupling of the inductor coil with the susceptor is increased in the second heating state compared to the first heating state.
EX24. An aerosol-generating device according to example EX21, EX22 or EX23, wherein the control circuitry is configured to trigger adjustment of the frequency of the alternating current between the first and second values or range of values as a function of one or more of: a) a puff count over a usage session; b) time elapsed since commencement of a usage session; c) detection of a puff in a usage session.
EX25. An aerosol-generating device according to any one of examples EX21 to EX24 wherein the control circuitry is configured to adjust the frequency of the alternating current from the first frequency value or range of values to the second frequency value or range of values in response to receiving a signal indicative of a user puff.
EX26. An aerosol-generating device according to any one of examples EX21 to EX25 wherein the control circuitry is configured to maintain the frequency of the alternating current at the second frequency value or range of values for a predetermined period of time after receiving the signal indicative of a puff being applied to the aerosol-generating system.
EX27. An aerosol-generating device according to example EX26, wherein the control circuitry is configured to, after elapse of the predetermined period of time, adjust the frequency of the alternating current from the second frequency value or range of values to a third frequency value or range of values.
EX28. An aerosol-generating device according to example EX27, wherein the third frequency value or range of values is farther away than the second frequency value or range of values from the resonant frequency of the electric heating arrangement, such that the inductive coupling of the inductor coil with the susceptor is reduced in the third heating state compared to the second heating state.
EX29. An aerosol-generating device according to any preceding example, wherein the control circuitry is configured to activate or adjust the supply of direct current to the inductor coil as a function of one or more of a) a puff count over a usage session; b) time elapsed since commencement of a usage session; and c) detection of a puff in a usage session.
EX30. An aerosol-generating device according to any preceding example, wherein the control circuitry is configured to activate or increase the supply of direct current to the inductor coil in response to the control circuitry receiving a signal indicative of a user puff.
EX31. An aerosol-generating device according to any preceding example, wherein the control circuitry is configured to switch between one or more of the following operational states:
a) a first operational state in which the inductor coil is supplied with alternating current alone;
b) a second operational state in which the inductor coil is supplied with direct current alone; and
c) a third operational state in which the inductor coil is supplied with both alternating current and direct current.
EX32. An aerosol-generating device according to example EX31, wherein the control circuitry is configured to select between different ones of the first, second and third operational states as a function of one or more of:
a) a puff count over a usage session;
b) time elapsed since commencement of a usage session; and
c) detection of a puff in a usage session.
EX33. An aerosol-generating device according to any preceding example, wherein the inductor coil is in the chamber.
EX34. An aerosol-generating device according to any preceding example, wherein the inductor coil is configured to be in direct contact with an exterior surface of the aerosol-generating article.
EX35. An aerosol-generating device according to any preceding example, wherein the aerosol-generating device further comprises a thermally conductive bridging element, the bridging element positioned in direct contact with the inductor coil and configured to contact an exterior surface of the aerosol-generating article so as to conduct heat generated in the inductor coil to the aerosol-generating article.
EX36. An aerosol-generating device according to example EX35, wherein at least one of the control circuitry and the thermally conductive bridging element is configured to prevent inductive coupling between the thermally conductive bridging element and the inductor coil during use.
EX37. An aerosol-generating device according to example EX36, wherein the control circuitry is configured to provide the alternating current with a frequency selected to prevent inductive coupling between the thermally conductive bridging element and the inductor coil during use.
EX38. An aerosol-generating device according to any one of examples EX35 to EX37, wherein the thermally conductive bridging element is formed from a non-electrically conductive material.
EX39. An aerosol-generating device according to any one of examples EX35 to EX38, wherein the thermally conductive bridging element is formed from a non-inductively heatable material.
EX40. An aerosol-generating device according to any one of examples EX35 to EX39, wherein the power supply and the control circuitry are connected to the thermally conductive bridging element and configured to provide an electric current to the thermally conductive bridging element during use to resistively heat the thermally conductive bridging element.
EX41. An aerosol-generating device according to any preceding example, wherein the inductor coil is configured to surround the aerosol-forming article when the aerosol forming article is received in the chamber.
EX42. An aerosol-generating device according to any preceding example, wherein the susceptor comprises a susceptor element.
EX43. An aerosol-generating device according to example EX42, wherein the aerosol-generating device comprises the susceptor element and the susceptor element is within the chamber.
EX44. An aerosol-generating device according to example EX43, wherein the susceptor element is arranged to be positioned within the aerosol-forming article when the aerosol forming article is received in the chamber.
EX45. An aerosol-generating device according to example EX43 or EX44, wherein the susceptor element is an elongate susceptor element extending into the chamber from the closed second end of the chamber.
EX46. An aerosol-generating device according to any one of examples EX42 to EX45, wherein at least a portion of the elongate susceptor element is positioned inside the inductor coil.
EX47. An aerosol-generating device according to any one of examples EX42 to EX46, wherein the susceptor element forms all or part of a pin or blade configured to penetrate the aerosol-forming article when the aerosol forming article is received in the chamber.
EX48. An aerosol-generating device according to any preceding example, wherein the inductor coil is suspended inside the chamber.
EX49. An aerosol-generating device according to any preceding example, wherein the inductor coil comprises a helical coil.
EX50. An aerosol-generating device according to any preceding example, wherein the helical coil comprises a first end and a second end, and wherein the housing contacts the inductor coil only at the first end and the second end of the inductor coil.
EX51. An aerosol-generating device according to any preceding example, wherein the housing comprises an inner surface at least partially defining the chamber, and wherein each of the first end of the inductor coil and the second end of the inductor coil abut the inner surface of the housing.
EX52. An aerosol-generating device according to example EX51, wherein the inner surface of the housing defines a first recess and a second recess, wherein the first end of the inductor coil is positioned within the first recess and wherein the second end of the inductor coil is positioned within the second recess.
EX53. An aerosol-generating device according to example EX51 or EX52, wherein the inner surface of the housing defines a first slot and a second slot, wherein the first end of the inductor coil extends through the first slot and wherein the second end of the inductor coil extends through the second slot.
EX54. An aerosol-generating device according to any one of examples EX51, EX52 or EX53, wherein an outer surface of the inductor coil is spaced apart from the inner surface of the housing.
EX55. An aerosol-generating device according to any preceding example, wherein the chamber comprises an open first end through which at least a portion of an aerosol-generating article may be inserted into the chamber and a closed second end opposite the open first end.
EX56. An aerosol-generating device according to any preceding example, wherein the aerosol-generating device further comprises an airflow channel defined between an inner surface of the housing and an outer surface of the inductor coil, wherein the airflow channel provides fluid communication between a first end of the chamber and a second end of the chamber.
EX57. An aerosol-generating device according to any preceding example, wherein the aerosol-generating device further comprises at least one protrusion extending into the chamber from a closed second end of the chamber.
EX58. An aerosol-generating device according to example EX57, wherein the housing comprises an end wall defining the closed second end of the chamber, and wherein the at least one protrusion extends into the chamber from the end wall.
EX59. An aerosol-generating device according to example EX58, wherein the at least one protrusion is formed integrally with the end wall.
EX60. An aerosol-generating device according to example EX57, EX58 or EX59, wherein the at least one protrusion comprises at least three protrusions.
EX61. An aerosol-generating device according to example EX60, wherein the chamber has a longitudinal axis defining a first direction along which at least a portion of an aerosol-generating article may be inserted into the chamber, and wherein the at least three protrusions are equidistantly spaced from each other in a circumferential direction around the longitudinal axis.
EX62. An aerosol-generating device according to any preceding example, wherein the inductor coil is arranged so that, when an aerosol-generating article is inserted into the chamber, at least part of the aerosol-generating article is received within the inductor coil.
EX63. An aerosol-generating device according to any preceding example, wherein the inductor coil is arranged so that, when an aerosol-generating article is inserted into the chamber, the inductor coil directly contacts the aerosol-generating article.
EX64. An aerosol-generating device according to any preceding example, wherein the inductor coil is formed from a coiled wire comprising an electrically conductive core and a coating on the electrically conductive core.
EX65. An aerosol-generating device according to example EX64, wherein the coating is electrically insulating, for example the coating may comprise at least one of a polymer, a ceramic, and a glass.
EX66. An aerosol-generating device according to any preceding example, wherein the inductor coil comprises:
a first tubular portion of electrically conductive material;
a second tubular portion of electrically conductive material; and
a helical coil of electrically conductive material extending between the first tubular portion of electrically conductive material and the second tubular portion of electrically conductive material.
EX67. An aerosol-generating device according to example EX66, wherein the helical coil is formed integrally with the first tubular portion and the second tubular portion.
EX68. An aerosol-generating device according to example EX66 or EX67, wherein each of the first tubular portion, the second tubular portion, and each turn of the helical coil has a maximum width extending in a direction parallel to a longitudinal axis of the inductor coil, wherein the maximum width of each of the first tubular portion and the second tubular portion is greater than the maximum width of each turn of the helical coil.
EX69. An aerosol-generating device according to example EX66, EX67 or EX68, wherein the inductor coil comprises a plurality of discrete apertures in at least one of the first tubular portion of electrically conductive material and the second tubular portion of electrically conductive material.
EX70. An aerosol-generating device according to example EX69, wherein the plurality of discrete apertures are present in both the first tubular portion of electrically conductive material and the second tubular portion of electrically conductive material.
EX71. An aerosol-generating device according to example EX69 or EX70, wherein the plurality of discrete apertures are distributed symmetrically in a circumferential direction extending around a longitudinal axis of the inductor coil.
EX72. An aerosol-generating device according to any one of examples EX66 to EX71, wherein the inductor coil further comprises a layer of electrically insulating material extending around an outer surface of the first tubular portion, the second tubular portion and the helical coil.
EX73. An aerosol-generating device according to example EX72, wherein the layer of electrically insulating material comprises a strip of the electrically insulating material extending around the outer surface of the first tubular portion, the second tubular portion and the helical coil.
EX74. An aerosol-generating device according to example EX73, wherein the strip of electrically insulating material extends in a helical shape around the outer surface of the first tubular portion, the second tubular portion and the helical coil.
EX75. An aerosol-generating device according to example EX73 or EX74, wherein the helical strip of electrically insulating material is wound in a first direction, wherein the helical coil turns in a second direction, and wherein the second direction is opposite to the first direction.
EX76. An aerosol-generating device according to example EX72, wherein The layer of electrically insulating is overmoulded on the outer surface of the first tubular portion, the second tubular portion and the helical coil.
EX77. An aerosol-generating device according to any one of examples EX66 to EX75, wherein The helical coil of electrically conductive material may have an inner surface, and at least one edge of the turns of the helical coil may comprises a bevel, a chamfer or a fillet.
EX78. An aerosol-generating device according to any preceding example, wherein the inductor coil comprises a core layer comprising a material of a first electrical resistivity and an outer layer comprising a material of a second electrical resistivity, wherein the first electrical resistivity is higher than the second electrical resistivity.
EX79. An aerosol-generating device according to any preceding example, wherein the power supply comprises a first DC power source.
EX80. An aerosol-generating device according to example EX79, wherein the first DC power source is a battery.
EX81. An aerosol-generating device according to example EX79 or EX80, wherein the control circuitry comprises a DC/AC converter connected to the first DC power source.
EX82. An aerosol-generating device according to any preceding example, wherein the control circuitry comprises power supply electronics configured to operate at high frequency.
EX83. An aerosol-generating device according to any one of examples EX79 to EX82, wherein the power supply electronics comprises the DC/AC converter connected to the first DC power source, the DC/AC converter including a Class-E power amplifier including a first transistor switch and an LC load network.
EX84. An aerosol-generating device according to example EX83, wherein the LC load network comprises a shunt capacitor and a series connection of a capacitor and the inductor coil.
EX85. An aerosol-generating device according to example EX84, wherein the power supply electronics include a second DC power source connected to the LC load network at a position between the capacitor and the inductor coil for supplying DC current to the inductor coil.
EX86. An aerosol-generating device according to example EX85, wherein the second DC power source is the same power source as the first DC power source.
EX87. An aerosol-generating device according to example EX85 or EX86, wherein the power supply electronics includes a choke inductor between the second DC power source and the capacitor, wherein the choke inductor preferably has a higher inductance value than the inductor coil.
EX88. An aerosol-generating device according to any one of examples EX84 to EX87, wherein the power supply electronics includes a choke inductor between the first DC power source and the capacitor.
EX89. An aerosol-generating device according to example EX85, wherein the power supply electronics includes a second switch between the second DC power source and the inductor coil.
EX90. An aerosol-generating device according to example EX84, wherein the power supply electronics includes second capacitor connected in parallel with the inductor coil.
EX91. An aerosol-generating system comprising:
an aerosol-generating article comprising an aerosol-generating substrate; and
an aerosol-generating device according to any of the preceding examples, wherein the aerosol-generating article is received in the chamber of the aerosol-generating device.
EX92. An aerosol-generating system according to example EX91, wherein the aerosol-generating article comprises one or more susceptors.
EX93. An aerosol-generating system according to example EX91 or EX92, wherein the aerosol-generating article comprises tobacco material.
EX94. A method of controlling an aerosol-generating system to generate an aerosol, the system comprising:
an aerosol-generating article comprising an aerosol-generating substrate;
a housing defining a chamber receiving at least a portion of the aerosol-generating article;
an inductor coil disposed in the housing;
at least one power supply for providing electrical power to the inductor coil; and
control circuitry configured to control the supply of power from the at least one power supply to the inductor coil,
the method comprising:
providing an alternating current to the inductor coil, such that the inductor coil generates an alternating magnetic field to inductively heat a susceptor within the aerosol-generating article, and
providing a direct current to the inductor coil to resistively heat the inductor coil and thereby heat the aerosol-generating article.
EX95. A method according to example EX94, wherein the method comprises adjusting the alternating current during operation of the device to adjust an amount of heating provided by inductive heating.
EX96. A method according to example EX94 or EX95, wherein the method comprises adjusting the direct current to inductor coil during operation of the device to adjust an amount of heating provided by resistive heating.
EX97. A method according to example EX94, EX95 or EX96, wherein the method comprises providing the alternating current and the direct current to the inductor coil at different times.
EX98. A method according to any one of examples EX94 to EX97, wherein the method comprises, following activation of the device, initially providing alternating current to the inductor coil and subsequently providing direct current to the inductor coil.
EX99. A method according to any one of examples EX94 to EX98, wherein the method comprises providing both alternating current and direct current to the inductor coil concurrently.
EX100. A method according to any one of examples EX94 to EX99, wherein the method comprises altering a magnitude of the direct current during operation of the device to adjust an amount of heat generated in the inductor coil as a result of the direct current.
EX101. A method according to any one of examples EX94 to EX100, wherein the method comprises altering a magnitude of the alternating current during operation of the device to adjust an amount of heat generated in the susceptor and in the inductor coil as a result of the alternating current.
EX102. A method according to any one of examples EX94 to EX101, wherein the method comprises adjusting a frequency of the alternating current during operation of the device to adjust an amount of heat generated in the susceptor and in the inductor coil as a result of the alternating current.
EX103. A method according to any one of examples EX94 to EX101, wherein the method comprises adjusting the direct current provided to the inductor coil to maintain the temperature of the inductor coil at a target temperature or to follow a target temperature profile.
EX104. A method according to any one of examples EX94 to EX103, wherein the method comprises adjusting the alternating current provided to the inductor coil to maintain the temperature of the susceptor at a target temperature or to follow a target temperature profile.

The invention is further described, by way of example only, with reference to the accompanying drawings in which:

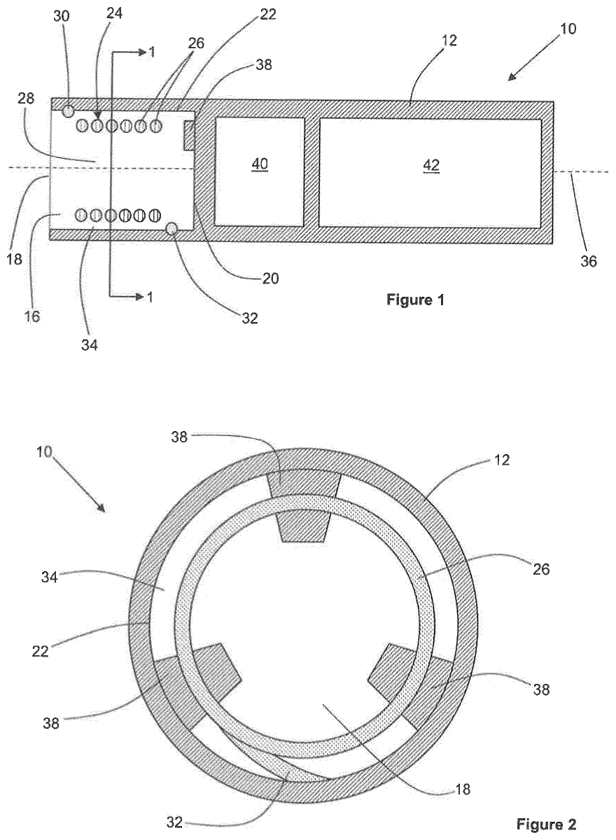

FIG. 1 shows a side cross-sectional view of an aerosol-generating device according to a first embodiment;

FIG. 2 shows an axial cross-sectional view of the aerosol-generating device of FIG. 1 along line 1-1;

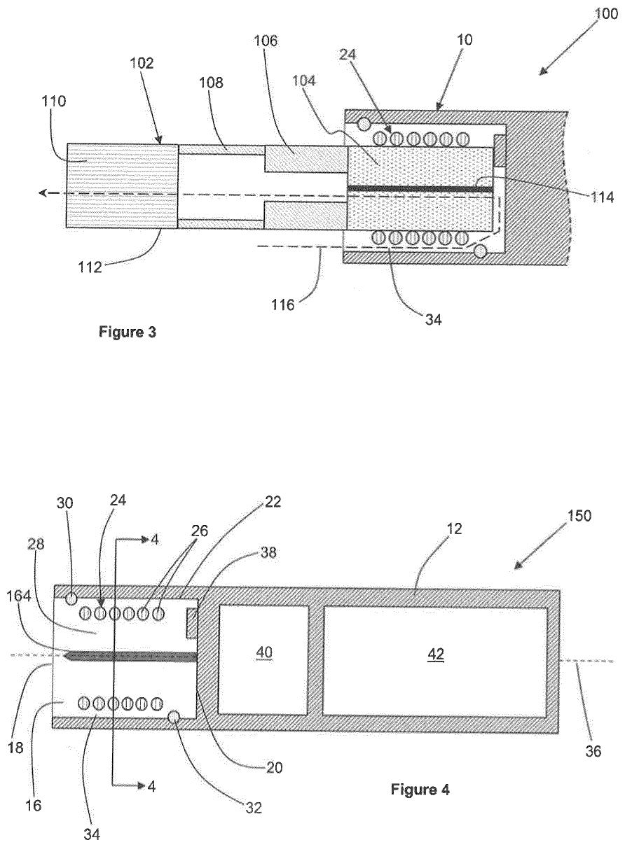

FIG. 3 shows a side cross-sectional view of an aerosol-generating system comprising the aerosol-generating device of FIG. 1;

FIG. 4 shows a side cross-sectional view of an aerosol-generating device according to a second embodiment;

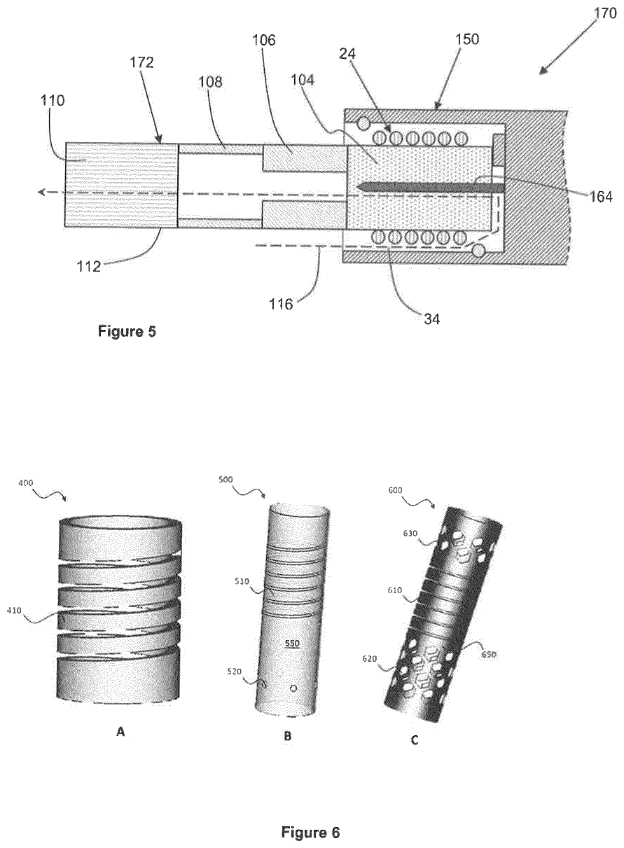

FIG. 5 shows a side cross-sectional view of an aerosol-generating system comprising the aerosol-generating device of FIG. 4;

FIG. 6 illustrates possible forms of inductor coil for the devices of FIGS. 1 to 5;

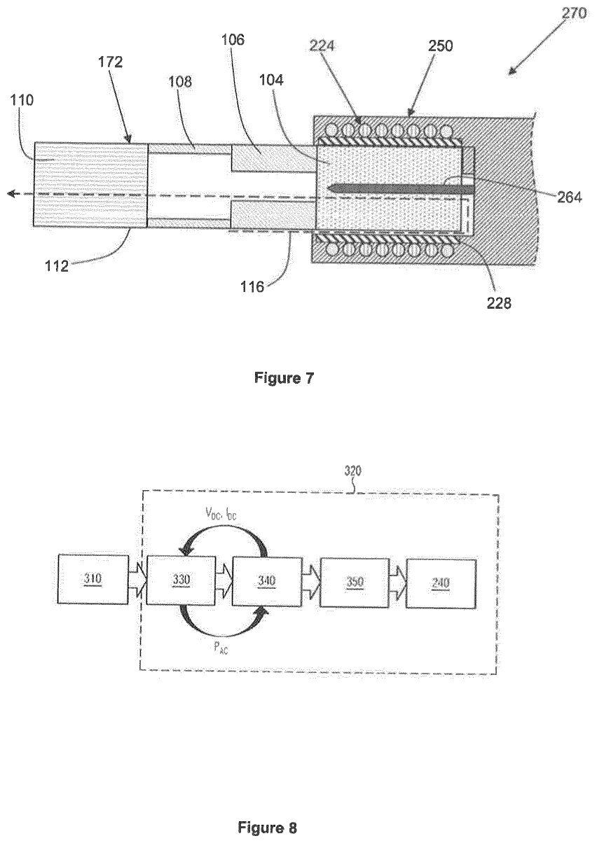

FIG. 7 illustrates the provision of a thermal bridging element between an inductor coil and an aerosol-generating article;

FIG. 8 is a block diagram showing an inductive heating arrangement of the aerosol-generating devices described in relation to FIGS. 1 to 5;

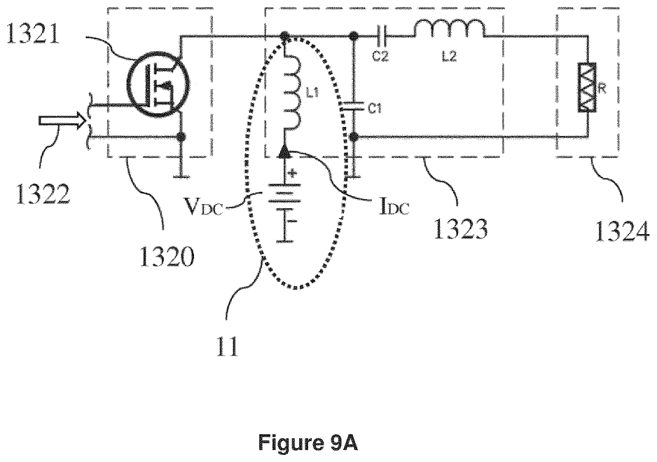

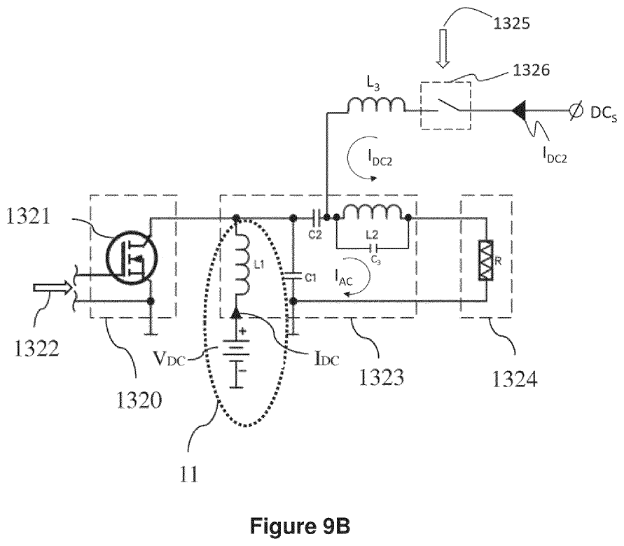

FIG. 9A is a schematic diagram showing a first embodiment of electrical circuitry of the aerosol-generating devices described in relation to FIGS. 1 to 5;

FIG. 9B is a schematic diagram showing a second embodiment of electrical circuitry of the aerosol-generating devices described in relation to FIGS. 1 to 5;

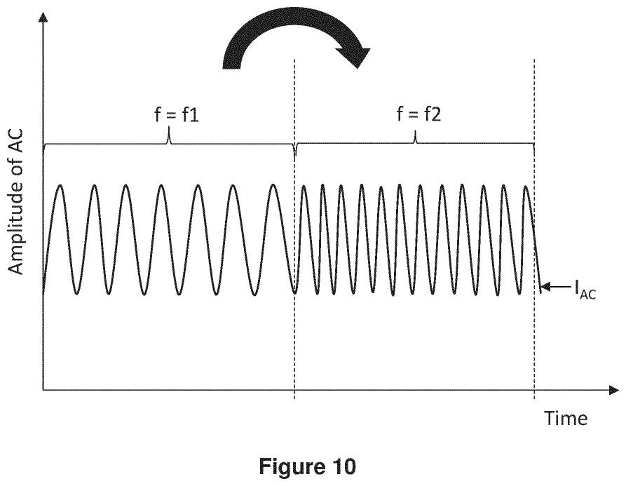

FIG. 10 illustrates the application of AC current to an inductor coil over first and second phases of operation and a change in frequency of the AC current between the first and second phases;

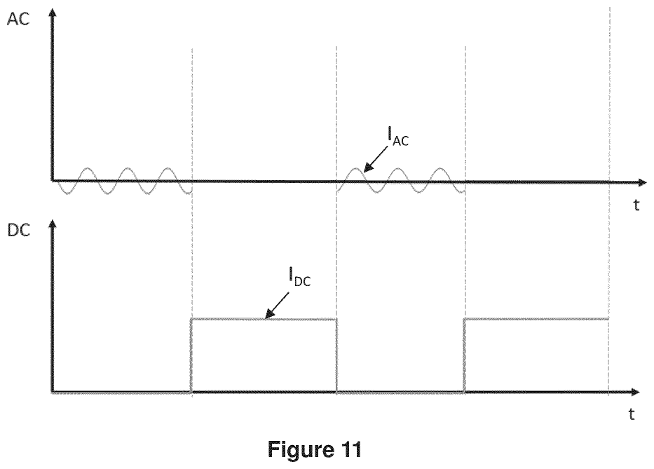

FIG. 11 illustrates the alternate application of AC and DC current to an inductor coil in successive phases of operation;

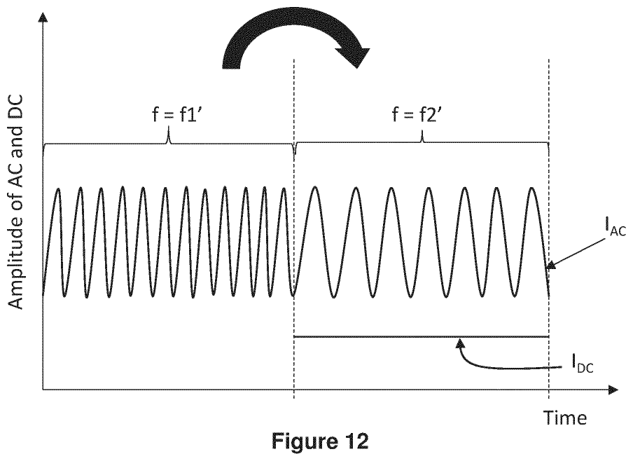

FIG. 12 illustrates the simultaneous application of AC and DC current to an inductor coil during at least one phase of operation and a change in frequency of the AC current between successive phases;

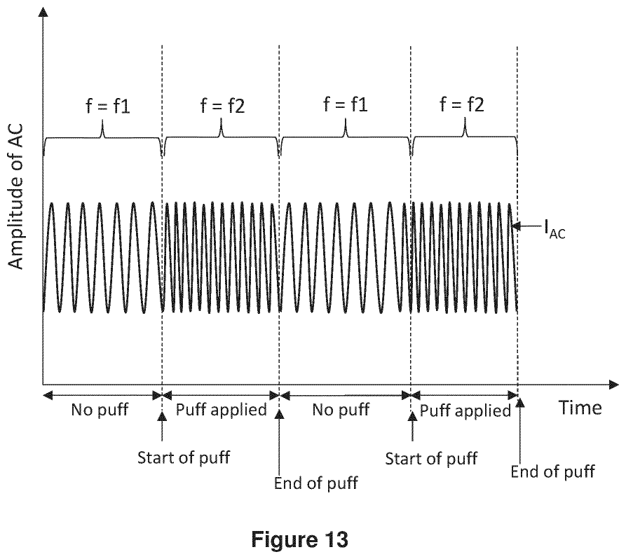

FIG. 13 illustrates the application of AC current to an inductor coil and a change in frequency of the AC current according to whether or not a puff is applied;

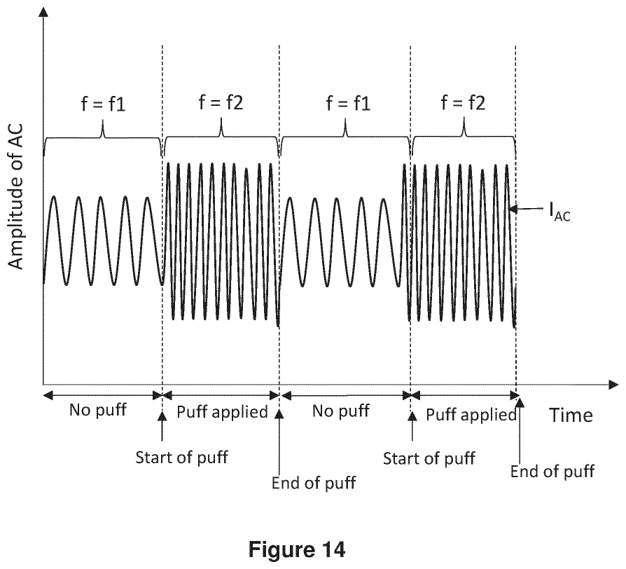

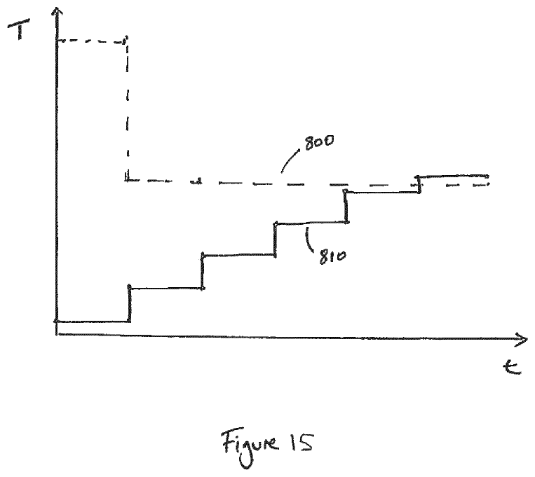

FIG. 14 is a variation to FIG. 13, in which both the frequency and magnitude of the AC current is varied according to whether or not a puff is applied; and

FIG. 15 illustrates target temperature profiles for a susceptor element and an inductor coil in an aerosol-generating system as described with reference to FIGS. 1 to 5.

FIGS. 1 and 2 show an aerosol-generating device 10 in accordance with a first embodiment. The aerosol-generating device 10 comprises a housing 12 defining a chamber 16 for receiving a portion of an aerosol-generating article. The chamber 16 comprises an open end 18 through which an aerosol-generating article may be inserted into the chamber 16 and a closed end 20 opposite the open end 18. A cylindrical wall 22 of the chamber 16 extends between the open end 18 and the closed end 20.

The aerosol-generating device 10 also comprises an inductor coil 24 comprising a plurality of windings 26 disposed within the chamber 16. The plurality of windings 26 of the inductor coil 24 define a lumen 28 in which a portion of an aerosol-generating article is received when the aerosol-generating article is inserted into the chamber 16. Advantageously, positioning the inductor coil 24 in direct contact with an aerosol-generating article received within the chamber 16 facilitates the transfer of heat generated by resistive heating of the inductor coil 24 to the aerosol-generating article.

The inductor coil 24 comprises a first end 30 positioned towards the open end 18 of the chamber 16 and a second end 32 positioned towards the closed end 20 of the chamber 16. Each of the first end 30 and the second end 32 is received within a portion of the cylindrical wall 22 of the chamber 16 to retain the inductor coil 24 within the chamber 16. The cylindrical wall 22 of the chamber 16 may define first and second recesses, slots, or apertures in which the first and second ends 30, 32 of the inductor coil 24 are respectively received. Alternatively, the first and second ends 30, 32 of the inductor coil 24 may be secured to the cylindrical wall 22 of the chamber 16 by overmoulding the housing 12 over the first and second ends 30, 32 of the inductor coil 24 during manufacture of the housing 12.

The inductor coil 24 is suspended within the chamber 16 by the first and second ends 30, 32 of the inductor coil 24 so that the windings 26 of the inductor coil 24 are spaced apart from the cylindrical wall 22 of the chamber 16. Therefore, the inductor coil 24 contacts the housing 12 only at the first and second ends 30, 32 of the inductor coil 24. Spacing the windings 26 of the inductor coil 24 from the cylindrical wall 22 of the chamber 16 defines an annular gap 34 between the cylindrical wall 22 of the chamber 16 and the windings 26 of the inductor coil 24. Advantageously, the annular gap 34 reduces or minimises the transfer of heat generated by resistive heating of the inductor coil 24 to the housing 12. Advantageously, the annular gap 34 facilitates airflow through the chamber 16 when an aerosol-generating article is received within the chamber 16.

To facilitate insertion of an aerosol-generating article into the chamber 16, the inductor coil 24 is arranged concentrically about a central axis 36 of the aerosol-generating device 10. To facilitate a secure positioning of the inductor coil 24 in the chamber 16, the first and second ends 30, 32 of the inductor coil 24 are retained by diametrically opposed portions of the cylindrical wall 22 of the chamber 16.

The housing 12 also defines a plurality of protrusions 38 extending into the chamber 16 from the closed end 20 of the chamber 16. As will be further described below, the plurality of protrusions 38 function to maintain a gap between an end of an aerosol-generating article and the closed end 20 of the chamber 16 when the aerosol-generating article is fully inserted into the chamber 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the chamber 16 may be varied.

The aerosol-generating device 10 also comprises control circuitry 40 and a power supply 42 connected to the inductor coil 24. The control circuitry 40 is configured to provide an alternating electric current from the power supply 42 to the inductor coil 24 to generate an alternating magnetic field.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 and the inductor coil 24 so that the aerosol-forming substrate 104 and the susceptor element 114 are positioned inside the lumen 28 defined by the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol. As is described in more detail below, the level of inductive coupling between the inductor coil 24 and the susceptor element 114 (and consequently, the heating of the susceptor 114) is affected by the frequency of the alternating current to the inductor coil 24.

Airflow through the aerosol-generating system 100 during use is illustrated by the dashed line 116 in FIG. 3. When a user draws on the mouthpiece 110 of the aerosol-generating article 102, a negative pressure is generated in the chamber 16. The negative pressure draws air into the chamber 16 via the open end 18 of the chamber. The air entering the chamber 16 then flows through the annular gap 34 between the inductor coil 24 and the cylindrical wall 22 of the chamber 16. When the airflow reaches the closed end 20 of the chamber 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the chamber 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 4 shows a cross-sectional view of an aerosol-generating device 150 according to a second embodiment. The aerosol-generating device 150 is similar to the aerosol-generating device 10 described with reference to FIGS. 1 and 2 and like reference numerals are used to designate like parts.

The aerosol-generating device 150 differs from the aerosol-generating device 10 by the addition of a susceptor element 164. The susceptor element 164 has an elongate shape and extends into the chamber 16 from the closed end 20 of the chamber 16. The susceptor element 164 extends along the central axis 36 of the aerosol-generating device 150 so that the inductor coil 24 extends concentrically around the susceptor element 164.

FIG. 5 shows a cross-sectional view of an aerosol-generating system 170 comprising the aerosol-generating device 150 of FIG. 4 and an aerosol-generating article 172. The aerosol-generating system 170 is similar to the aerosol-generating system 100 described with reference to FIG. 3 and like reference numerals are used to designate like parts.

The aerosol-generating system 170 differs from aerosol-generating system 100 by the absence of a susceptor element in the aerosol-generating article 172. When the aerosol-generating article 172 is inserted into the chamber 16, the susceptor element 164 of the aerosol-generating device 150 is received within the aerosol-forming substrate 104 of the aerosol-generating article 172. FIGS. 4 and 5 show the susceptor element 164 as having a pin- or blade-shaped profile, thereby facilitating penetration of the aerosol-forming substrate 104 by the susceptor element 164 during insertion of the aerosol-generating article 172 into the chamber 16 of the aerosol-generating device 150. The skilled person will appreciate that the susceptor element 164 may have a profile other than that shown in FIGS. 4 and 5.

Once the aerosol-generating article 172 has been inserted into the chamber 16, the operation of the aerosol-generating system 170 is identical to the operation of the aerosol-generating system 100 described with reference to FIG. 3.

FIG. 6 illustrates three possible alternative coil structures for the devices illustrated in FIGS. 1 to 5.

A first coil structure is marked as coil structure A. Coil structure A comprises a sleeve 400. A helical coil section 410 is formed by removal of material from the sleeve 400.

An insulating material may be arranged within the gaps where the material of the sleeve 400 has been removed. This has the advantage of structurally reinforcing the coil structure and may also facilitate the insertion of the aerosol generating article. It is also possible to wrap or overmould a layer of insulating material, like polyimide tape, around the helical coil section 410 or the sleeve 400. This would not significantly interfere with the heat transferred to the aerosol generating article but would improve the structural stability of the coil structure.

A second coil structure, marked as coil structure B, comprises a sleeve 500 similar to coil structure A including a helical coil section 510 obtained by material removal. Sleeve 500 comprises a downstream extended portion 550 which is used to couple the sleeve within the housing 12 of the chamber 16 of the aerosol-generating device. Extended portion 550 comprises through-holes 520 to allow airflow through the sleeve and into the aerosol generating article.

A third coil structure, coil structure C, comprises a sleeve 600 with a helical coil section 610 and a downstream extended region 650, which comprises through-holes 620 which are greater in size and in number than for the through-holes 520 of coil structure B. When compared to coil structure B, bigger openings 620 offer the advantage of reducing the mass of the structure and therefore significantly mitigates heat losses caused by heat conduction towards end regions of the sleeve.

Although the devices described so far all use helical shaped coils, it is possible to use other forms of inductor coil. In particular, one or more flat spiral coils or pancake coils could be used to both generate an alternating magnetic field within the chamber 16 and to provide for external heating from resistive heating of the coil itself. Such flat spiral coils could be shaped to conform to the side wall of the chamber and arranged to generate a magnetic field orthogonal to a longitudinal axis of the chamber. Where the inductor coil is intended to be in surface contact with an exterior surface of the aerosol-generating article, the use of a coil having a flat cross-sectional profile may facilitate conduction between the coil and the article of heat generated by resistive heating of the coil.

FIG. 7 shows a cross-sectional view of an aerosol-generating device 250 according to a third embodiment. The aerosol-generating device 250 is similar to the aerosol-generating device 150 described with reference to FIGS. 4 and 5 and like reference numerals are used to designate like parts.

The embodiment of FIG. 7 differs from the embodiment of FIGS. 4 and 5 in the position of the inductor coil 224 and in the provision of a thermal bridging element 228 between the coil 224 and the aerosol generating article 172. The inductor coil 224 is embedded or recessed within the housing of the device 250, and the thermal bridging element 228 formed from a thermally conductive material is placed in contact with the inductor coil 224. The thermal bridging element 228 is in the form of an austenitic steel tube. The thermal bridging element 228 partially defines a cylindrical wall of the chamber that extends between the open end and the closed end of the chamber. The thermal bridging element 228 is arranged so that an aerosol-generating article 172 is received within the thermal bridging element 228 and in direct contact with the thermal bridging element 228 when the aerosol-generating article is inserted into the chamber. Advantageously, direct contact between the thermal bridging element 228 and an aerosol-generating article 172 facilitates the transfer of heat from the thermal bridging element 228 to the aerosol-generating article.

The inductor coil 224 comprises a plurality of windings that extend around an outer surface of the thermal bridging element 228. The inductor coil 224 is arranged so that the plurality of windings are in direct contact with the outer surface of the thermal bridging element 228. Advantageously, positioning the inductor coil 224 in direct contact with an outer surface of the thermal bridging element 228 facilitates the transfer of heat generated by resistive heating of the inductor coil 224 to the thermal bridging element 228. The inductor coil 224 and the thermal bridging element 228 are arranged concentrically about a central axis of the aerosol-generating device 250.

The control of the devices described in FIGS. 1 to 7 will now be explained in detail.

FIG. 8 is a block diagram illustrating an exemplary configuration of components and circuitry for generating and providing an alternating current to an inductor coil of an aerosol-generating device, such as the inductor coil 24 of the aerosol-generating devices 10, 150 of FIGS. 1 and 4. A DC power source 310 is coupled to an inductive heating arrangement 320. The heating arrangement 320 comprises a controller 330, a DC/AC converter 340, a matching network 350 and an inductor coil 240. The DC power source 310 of FIG. 8 corresponds to or forms part of the power supply 42 of the aerosol-generating devices 10, 150 of FIGS. 1 and 4. The controller 330, DC/AC converter 340 and matching network 350 correspond to or form part of the control circuitry 40 of the aerosol-generating devices 10, 150 of FIGS. 1 and 4. The inductor coil 240 corresponds to the inductor coil 24 of the aerosol-generating devices 10, 150 of FIGS. 1 and 4. The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device, such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor coil 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 9A schematically illustrates a first embodiment of electrical circuitry for use in supplying the inductor coil 240 with electric energy. The DC/AC converter 340 preferably comprises a Class-E power amplifier. The Class-E power amplifier comprises a transistor switch 1320 comprising a Field Effect Transistor 1321, for example a Metal-Oxide-Semiconductor Field Effect Transistor, a transistor switch supply circuit indicated by the arrow 1322 for supplying a switching signal (gate-source voltage) to the Field Effect Transistor 1321, and an LC load network 1323 comprising a shunt capacitor C1 and a series connection of a capacitor C2 and inductor coil L2. Inductor coil L2 corresponds to inductor coil 240 of FIG. 8. In addition, DC power source 11, comprising a choke inductor L1, is shown for supplying the DC supply voltage V_{DC}, with the DC current I_{DC} being drawn from the DC power source 11 during operation. The ohmic resistance R represents the total ohmic load 1324, which is the sum of the ohmic resistance R_{coil} of the inductor coil L2 and the ohmic resistance R_{load} of the susceptor element. The DC power source 11 corresponds to the DC power source 310 of FIG. 8.

The transistor switch supply circuit 1322 may supply a switching voltage having a rectangular profile to the Field Effect Transistor 1321. As long as the Field Effect Transistor 1321 is conducting (in an “on”-state), it essentially constitutes a short circuit (low resistance) so that the entire current flows through the choke L₁ and the Field Effect Transistor 1321. When the Field Effect Transistor 1321 is non-conducting (in an “off”-state), the entire current flows into the LC load network 1323 since the Field Effect Transistor 1321 essentially represents an open circuit (high resistance). Switching the Field Effect Transistor 1321 between conducting (“on”) and non-conducting (“off”) states inverts the supplied DC voltage V_{DC} and DC current I_{DC} into an AC voltage V_{AC} and AC current I_{AC} flowing in the inductor coil L2, having frequency f.

In an alternative mode of operation, the transistor switch supply circuit 1322 is inactive so that the supplied DC current I_{DC} is not converted to AC current, but remains as direct current.

So, the circuit of FIG. 9A allows for supply to the inductor coil L2 of one of AC current I_{AC} or DC current I_{DC}, but not both I_{AC} and I_{DC} simultaneously.

FIG. 9B schematically illustrates a second embodiment of electrical circuitry for use in supplying the inductor coil 240 with electric energy. The circuitry of FIG. 9B includes all of the components of the circuitry of FIG. 9A, but includes additional circuitry. The additional circuitry is discussed below.

A DC feed to the inductor coil L2 is provided. A DC power supply DC_{S} is connected to the inductor coil L2 through a transistor switch 1326. An additional choke inductor L3 is arranged between DC power supply DC_{S} and the capacitor C2.

The transistor switch 1326 is driven by a transistor switch supply circuit indicated by the arrow 1325 for supplying the switching signal (gate-source voltage). The DC source DC_{S} could be a battery or in general any means capable of producing a DC current. In particular, the battery could be the same power source as the one generating the DC voltage V_{DC} for feeding to the DC/AC converter 340 in order to generate the AC current I_{AC}. When the switch 1326 is activated, a DC current I_{DC2} will flow through inductors L3 and L2.

Choke inductor L3 has the specific purpose of preventing the AC current I_{AC} from flowing through the DC source DC_{S}. For this purpose, advantageously, the inductance value of L3 is significantly higher than the inductance of inductor coil L2. Similarly, choke inductor L1 does not allow AC current to flow within DC source V_{DC}.

The circuit of FIG. 9B allows the simultaneous or alternate flow of a) AC current I_{AC} (generated by V_{DC}) flowing through capacitor C2, inductor coil L2 and capacitor C1, and b) direct current I_{DC2} through inductor L3 and inductor coil L2. Direct current I_{DC2} does not reach choke inductor L1 because of the presence of capacitor C2, which is seen by I_{DC2} as an open circuit.

The circuit could also operate without the choke inductor L3, as long as the circuit is set up for operating sequentially with AC current and DC current (that is AC and DC are not to be activated simultaneously).

As explained in detail below, it is also possible to resistively heat the inductor coil L2 by the AC current I_{AC} if the frequency of that current is such that there is little coupling to the susceptor element. It could also be advantageous to add a capacitor C3 in parallel to inductor coil L2. In this way, inductor coil L2 is more frequency selective. As explained below, the presence of capacitor C3 may greatly improve the process of switching from a frequency f_{susceptor} to a frequency f_{inductor coil} to change from internal to external heating as a result of AC current, since the difference between the two frequency values may be significantly reduced. In this way, the control may run smoother. Without capacitor C3, the two frequency values may be distant from each other, making the system slower to react.

Although the DC/AC converter 340 is illustrated as comprising a Class-E power amplifier, the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 8, the inductor coil 240 may receive the alternating current from the DC/AC converter 340 via the matching network 350 for optimum adaptation to the load, but the matching network 350 is not essential. The matching network 350 may comprise a small matching transformer. The matching network 350 may improve power transfer efficiency between the DC/AC converter 340 and the inductor coil 240.

As illustrated in FIGS. 1 and 4, the inductor coil 24 is located around the chamber 16 of the aerosol-generating device 10, 150. Accordingly, the high frequency alternating current I_{AC} supplied to the inductor coil 24 during operation of the aerosol-generating device 10, 150 causes the inductor coil to generate a high frequency alternating magnetic field within the chamber 16 of the aerosol-generating device 10, 150. The alternating magnetic field preferably has a frequency of between 1 and 30 megahertz, preferably between 2 and 10 megahertz, for example between 5 and 7 megahertz. As can be seen from FIGS. 3 and 5, when an aerosol-generating article 102, 172 is inserted into the chamber 16, the aerosol-forming substrate 104 of the aerosol-generating article is located adjacent to the inductor coil 24 so that the susceptor element 114, 164 is located within this alternating magnetic field. When the alternating magnetic field penetrates the susceptor element 114, 164, the alternating magnetic field causes heating of the susceptor element. For example, eddy currents are generated in the susceptor element 114, 164, which is heated as a result. Further heating is provided by magnetic hysteresis losses within the susceptor element 114, 164.

Similarly when the inductor coil 24 itself is resistively heated by the DC current I_{DC2} (and/or by the AC current I_{AC}), heat is transferred to the aerosol-generating article 102, 172 located adjacent to the inductor coil 24.

The heated susceptor element 114, 164 and/or the heated inductor coil 24 heats the aerosol-forming substrate 104 of the aerosol-generating article 102, 172 to a sufficient temperature to form an aerosol. The aerosol is drawn downstream through the aerosol-generating article 102, 172 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor element.

FIG. 10 illustrates one possible scheme for supplying current to the inductor coil 24, 240. The scheme of FIG. 10 could be implemented using the electrical circuitry of FIG. 9A. For the scheme shown in FIG. 10, AC current I_{AC} alone is supplied to the inductor coil 24, 240, with the frequency of the AC current I_{AC} changed from a first frequency f1 to a second frequency f2. In the embodiment shown in FIG. 10, frequencies f1 and f2 act over respective first and second time intervals. Frequencies f1 and f2 provide differing levels of inductive coupling between the inductor coil 24, 240 and susceptor element 114, 164. Explaining further, frequency f1 corresponds to a frequency f_{inductor coil}, in which the AC current I_{AC} creates a magnetic field that provides little to no coupling with the susceptor element 114, 164 and allows almost the totality of the energy in the supplied current to remain within the inductor coil 24, 240, resulting in most of the heat being generated by resistance heating of the inductor coil. So, the application of AC current I_{AC} of frequency f1 over the first time interval results in the aerosol-forming substrate 104 being predominantly heated externally of the substrate 104, through resistance heating of the inductor coil 24, 240. Frequency f2 corresponds a frequency f_{susceptor}, in which the AC current I_{AC} creates a varying magnetic field that best couples with the susceptor element 114, 164, so as to allow transfer of almost the totality of the energy to the susceptor element, resulting in most of the heat being generated by heating of the susceptor element. So, the application of AC current I_{AC} of frequency f2 over the second time interval results in the aerosol-forming substrate 104 being predominantly heated from within, through heating of the susceptor element 114, 164. So, the frequencies f1, f2 correspond to different heating modes or phases for the aerosol-generating device 10, 150. Alternatively, frequency f1 or f2 may correspond to a frequency fₜₒₜₐₗ, in which the AC current I_{AC} results in a simultaneous combination of heating of the susceptor element 114, 164 and resistance heating of the inductor coil 24, 240, thereby heating the aerosol-forming substrate 104 both internally and externally.

FIG. 11 illustrates another possible scheme for supplying current to the inductor coil 24, 240. In the scheme shown in FIG. 11, AC current I_{AC} is supplied at different times to DC current I_{DC}. The scheme of FIG. 11 could be implemented using the electrical circuitry of FIG. 9B. The top graph shows the AC current I_{AC} and the bottom graph shows the DC current I_{DC}. This scheme requires the controller 330 to operate transistor switches 1320 and 1326 (shown in FIG. 9B) alternately. With this scheme, heat may be transferred to the aerosol-forming substrate 104 from an internal source (through heating of the susceptor element 114, 164) and then from an external source (through heating of the inductor coil 24, 240) alternately. However, as indicated in the discussion of the scheme of FIG. 10, the degree of internal heating provided via the susceptor element 114, 164 will be dependent on the frequency of the AC current I_{AC} and the associated level of inductive coupling between the inductor coil 24, 240 and the susceptor element 114, 164.

FIG. 12 illustrates another possible scheme for supplying current to the inductor coil 24, 240. The scheme of FIG. 12 could be implemented using the electrical circuitry of FIG. 9B. In the scheme shown in FIG. 12, in a first phase AC current I_{AC} is supplied with a first frequency f1′ and no DC current is supplied. Frequency f1′ is chosen to maximise inductive coupling to the susceptor element 114, 164 and so maximise heating of the susceptor element. In a second phase AC current I_{AC} is supplied with a second frequency f2′ and DC current I_{DC} is also supplied simultaneously with lac. Frequency f2′ is chosen to reduce inductive coupling to the susceptor 114, 164 compared to frequency f1′ and so to provide greater heating of the inductor coil 24, 240 itself. The DC current I_{DC} also contributes to resistive heating of the inductor coil 24, 240. So, in the first phase the aerosol-forming substrate 104 is internally heated by the susceptor element 114, 164 and in the second phase the aerosol-forming substrate is externally heated by the inductor coil 24, 240.

FIG. 13 illustrates another possible scheme for supplying current to the inductor coil 24, 240. The scheme of FIG. 13 could be implemented using the electrical circuitry of FIG. 9A. In common with the scheme of FIG. 10, AC current I_{AC} alone is supplied to the inductor coil 24, 240, with the frequency of the AC current I_{AC} changed between a first frequency f1 and a second frequency f2. When no puff is detected as being applied to the aerosol-generating article 102, 172, the AC current I_{AC} having frequency f1 is supplied to the inductor coil 24, 240. However, upon detection of an applied puff by the control circuitry 40, the frequency of the AC current I_{AC} is switched to frequency f2, with frequency f2 maintained over the duration of the applied puff. Once a user has ceased applying a given puff, the frequency of the alternating current I_{AC} reverts back to frequency f1. FIG. 13 shows how the AC current frequency I_{AC} alternates between f1 and f2 depending on whether or not a puff is being applied. The aerosol-generating device 10, 150 may include a pressure sensor or temperature sensor to assist in the detection of an applied puff. It will also be appreciated that the inductor coil 24, 240 and susceptor element 114, 164 may indirectly function as a means of determining changes in temperature. The frequencies f1 and f2 may correspond to those of the scheme shown in FIG. 10. So, frequency f1 may correspond to a frequency f_{inductor coil}, in which the AC current I_{AC} creates a magnetic field that provides little to no coupling with the susceptor element 114, 164 and allows almost the totality of the energy in the supplied current to remain within the inductor coil 24, 240, resulting in most of the heat being generated by resistance heating of the inductor coil. So, the application of AC current I_{AC} of frequency f1 when no puff is detected results in the aerosol-forming substrate 104 being predominantly heated externally, through resistance heating of the inductor coil 24, 240. Frequency f2 corresponds a frequency f_{susceptor}, in which the AC current I_{AC} creates a varying magnetic field that best couples with the susceptor element 114, 164, so as to allow transfer of almost the totality of the energy to the susceptor element, resulting in most of the heat being generated by heating of the susceptor element. So, the application of AC current I_{AC} of frequency f2 over the duration of an applied puff results in the aerosol-forming substrate 104 being predominantly heated from within, through heating of the susceptor element 114, 164.

FIG. 14 illustrates another possible scheme for supplying current to the inductor coil 24, 240. The scheme of FIG. 14 could be implemented using the electrical circuitry of FIG. 9A. The scheme of FIG. 14 is a variation of the scheme of FIG. 13. In common with the scheme of FIG. 13, the frequency of the AC current I_{AC} alternates between first frequency f1 (corresponding to when no puff is applied to the aerosol-generating article 102, 172) and second frequency f2 (corresponding to when a puff is detected as having been applied to the aerosol-generating article). However, when application of a puff is detected, the magnitude of the AC current I_{AC} is also increased relative to the magnitude of the AC current employed when no puff is detected. The AC current I_{AC} of increased magnitude and frequency f2 is maintained over the duration of the applied puff, before reverting to frequency f1 and a reduced magnitude upon ceasing of the applied puff. As stated above for FIG. 13, frequency f2 corresponds a frequency f_{susceptor}, in which the AC current I_{AC} creates a varying magnetic field that best couples with the susceptor element 114, 164, so as to allow transfer of almost the totality of the energy in the supplied current to the susceptor element, resulting in most of the heat being generated by heating of the susceptor element. The increase in magnitude of the AC current I_{AC} when a puff is being applied enhances heating of the susceptor element 114, 164 compared to retaining the AC current at the same magnitude for frequencies f1 (no puff applied), f2 (puff being applied).

Of course there are any number of possible schemes for supplying AC and DC currents to the inductor coil 24, 240 to provide the desired combination of internal and external heating of the aerosol-forming substrate 104 over time. As discussed above, the frequency of the AC current can be chosen to provide a desired balance between heating of the susceptor element and heating of the coil. The control circuitry 40 can be configured to control the switches 1320 and 1326 to follow a particular profile of internal and external heating over time.

FIG. 15 illustrates one possible scheme with a target temperature profile for the susceptor element 114, 164 shown in dotted line 800 and a target temperature profile for the inductor coil 24, 240 shown by the solid line 810. In an initial phase, no DC current is supplied and the frequency of the AC current is chosen for maximum heating of the susceptor element 114, 164. This is to provide for rapid internal heating of the aerosol-forming substrate 104. This assists in minimising the delay between activating the aerosol-generating device and producing aerosol for the user.

After the initial phase, the target temperature for the susceptor element 114, 164 is reduced. The magnitude of the AC current is therefore reduced. At this point the temperature of the aerosol-forming substrate 104 has been significantly raised by heat transfer from the susceptor element 114, 164 and reducing the susceptor element temperature avoids overheating of the aerosol-forming substrate, which might lead to undesirable compounds in the aerosol. However, at this point a target temperature of the inductor coil 24, 240 is stepped up. DC current is supplied to the inductor coil 24, 240 to raise the temperature of the inductor coil and begin external heating of the aerosol-forming substrate 104.

As the usage session of the system progresses, the target temperature of the inductor coil 810 is raised, stepwise, until it is close to or the same as the target temperature of the susceptor element 800. This ensures that the outer regions of the aerosol-forming substrate 104 are fully depleted by the end of the usage session.

The target temperature profiles shown in FIG. 15 are just one example. The target temperature profiles can be arranged in any desired manner and need not have stepwise changes but instead may continuously vary. As described, the temperature of the inductor coil 24, 240 may be raised by AC currents of appropriate frequency as well as by a DC current.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device comprising:
a housing defining a chamber configured to receive at least a portion of an aerosol-generating article;
an inductor coil disposed in the housing, wherein the inductor coil is configured to surround the aerosol-generating article when the aerosol-generating article is received in the chamber;
at least one power supply configured to provide electrical power to the inductor coil; and
control circuitry configured to:
control a supply of power from the at least one power supply to the inductor coil,
provide an alternating current to the inductor coil, such that the inductor coil generates an alternating magnetic field to inductively heat a susceptor within the aerosol-generating article,
provide a direct current to the inductor coil to resistively heat the inductor coil and thereby heat the aerosol-generating article, and
following activation of the aerosol-generating device, initially provide alternating current to the inductor coil and to subsequently provide direct current to the inductor coil.

17. An aerosol-generating device, comprising:
a housing defining a chamber configured to receive at least a portion of an aerosol-generating article;
an inductor coil disposed in the housing, wherein the inductor coil is configured to surround the aerosol-generating article when the aerosol-generating article is received in the chamber;
at least one power supply configured to provide electrical power to the inductor coil; and
control circuitry configured to:
control a supply of power from the at least one power supply to the inductor coil,
provide an alternating current to the inductor coil, such that the inductor coil generates an alternating magnetic field to inductively heat a susceptor within the aerosol-generating article,
provide a direct current to the inductor coil to resistively heat the inductor coil and thereby heat the aerosol-generating article, and
provide both alternating current and direct current to the inductor coil concurrently.

18. The aerosol-generating device according to claim 16, wherein the control circuitry is further configured to adjust the alternating current provided to the inductor coil during operation of the aerosol-generating device to adjust an amount of heating provided by inductive heating.

19. The aerosol-generating device according to claim 16, wherein the control circuitry is further configured to adjust the direct current provided to the inductor coil during operation of the aerosol-generating device to adjust an amount of heating provided by resistive heating.

20. The aerosol-generating device according to claim 16, wherein the control circuitry is further configured to provide the alternating current and the direct current to the inductor coil at different times.

21. The aerosol-generating device according to claim 16, wherein the control circuitry is further configured to adjust a frequency of the alternating current during operation of the aerosol-generating device to adjust an amount of heat generated in the susceptor and in the inductor coil as a result of the alternating current.

22. The aerosol-generating device according to claim 16, wherein the control circuitry is further configured to adjust the direct current provided to the inductor coil to maintain a temperature of the inductor coil at a target temperature or to follow a target temperature profile.

23. The aerosol-generating device according to claim 16, wherein the control circuitry is further configured to adjust the alternating current provided to the inductor coil to maintain a temperature of the susceptor at a target temperature or to follow a target temperature profile.

24. An aerosol-generating system, comprising:
an aerosol-generating article comprising an aerosol-generating substrate; and
the aerosol-generating device according to claim 16,
wherein the aerosol-generating article is received in the chamber of the aerosol-generating device.

25. A method of controlling an aerosol-generating system to generate an aerosol,
the aerosol-generating system comprising:
an aerosol-generating article comprising an aerosol-generating substrate,
a housing defining a chamber receiving at least a portion of the aerosol-generating article,
an inductor coil disposed in the housing, wherein the inductor coil surrounds the aerosol-generating article received in the chamber,
at least one power supply for providing electrical power to the inductor coil, and
control circuitry configured to control a supply of power from the at least one power supply to the inductor coil; and
the method comprising:
providing an alternating current to the inductor coil, such that the inductor coil generates an alternating magnetic field to inductively heat a susceptor within the aerosol-generating article,
providing a direct current to the inductor coil to resistively heat the inductor coil and thereby heat the aerosol-generating article, and
following activation of the aerosol-generating device, initially providing alternating current to the inductor coil and subsequently providing direct current to the inductor coil.

26. The method according to claim 25, further comprising providing both alternating current and direct current to the inductor coil concurrently.

27. The method according to claim 25, further comprising adjusting the alternating current during operation of the aerosol-generating device to adjust an amount of heating provided by inductive heating.

28. The method according to claim 25, further comprising adjusting the direct current to inductor coil during operation of the aerosol-generating device to adjust an amount of heating provided by resistive heating.

29. The method according to claim 25, further comprising adjusting the direct current provided to the inductor coil to maintain a temperature of the inductor coil at a target temperature or to follow a target temperature profile.

30. The method according to claim 25, further comprising adjusting the alternating current provided to the inductor coil to maintain a temperature of the susceptor at a target temperature or to follow a target temperature profile.
